(19) United States
(12) Patent Application Publication
(10) Pub. No.: US 2026/0171334 A1
(43) Pub. Date: Jun. 18, 2026

(54) METHOD FOR DISASSEMBLING AND ASSEMBLING AN OPERATING PART OF AN OPERATING DEVICE, AND OPERATING DEVICE

(71) Applicant: AUDI AG, Ingolstadt (DE)

(72) Inventor: Oliver ZINK, Inning a. Ammersee (DE)

(73) Assignee: AUDI AG, Ingolstadt (DE)

(21) Appl. No.: 19/425,546

(22) Filed: Dec. 18, 2025

(30) Foreign Application Priority Data
Dec. 18, 2024 (DE) 10 2024 138 730.0

(51) Int. Cl. H01H 19/14; B60K 35/10; H01H 11/00; H01H 19/04

(52) U.S. Cl. CPC H01H 19/14; B60K 35/10; H01H 11/00; H01H 19/04; B60K 2360/126

(57) ABSTRACT

A method for disassembling an operating part from a receptacle unit. The operating part comprises a housing, an operating element and a rotary ring which surrounds the operating element. Based on a compressive force being exerted on the operating element, a rotating movement of the rotary ring relative to the operating element is blocked, and the housing located in an installed position and disposed in the receptacle unit is displaced along a direction of a contact face of the receptacle unit that lies opposite a receptacle opening. Furthermore, based on a rotating movement being exerted on the rotary ring, as a result of which the operating part is rotated in such a manner that the housing is guided out of the installed position. Subsequently, the compressive force is canceled, and the housing is moved to the receptacle opening of the receptacle unit for disassembling the operating part.

### CROSS REFERENCE TO RELATED APPLICATIONS

This application is a based upon and claims the priority benefit of German Application No. 10 2024 138 730.0 filed on Dec. 18, 2024, the entire contents of which are incorporated by reference herein.

### BACKGROUND

### 1. Field

One aspect of the invention relates to a method for disassembling an operating part of an operating device from a receptacle unit of the operating device. A further aspect of the invention relates to a method for installing an operating part of an operating device in a receptacle unit of the operating device. A further aspect of the invention relates to an operating device, to a faceplate having an operating device, and to a motor vehicle having an operating device.

In operating parts for motor vehicles, such as a volume control, for example, the operating parts are fastened to a faceplate on the center console of the motor vehicle from below. For example, the operating parts are snap-fitted to the faceplate from below. For this purpose, the faceplate of the center console first has to be dismantled and subsequently installed again.

### 2. Description of the Related Art

In this context, DE 10 2012 109 607 A1 describes a possibility for installing a touch-sensitive rotary knob switch. The rotary knob switch comprises a housing which has an upper cover and a lower cover. A multiplicity of elastic latching cams with ratchets are disposed so as to be spaced apart on the external circumference of the upper cover during insertion of the housing. The housing is inserted into a positioning hole at a predetermined location. In the process, the housing can be latched by the latching cams in order to prevent water entering from the outside via the external circumference of the upper cover and into the base.

A rotary switch for installation in a dashboard of a motor vehicle is described in DE 20 2004 006 783 U1. The rotary switch comprises a switch housing, an activation shaft which is rotatably disposed in the switch housing, a rotary knob which is attached to one end of the activation shaft, and an annular faceplate which surrounds the rotary knob and is releasably fastened to the switch housing. The faceplate is connected to the switch housing by way of a latching mechanism which is releasable by a relative rotation between the faceplate and the switch housing. Furthermore, in a specific rotational position the rotary knob is axially displaceable and as a result able to be co-rotationally coupled to the faceplate.

The disadvantage in using operating parts of this type is that the work steps necessary for assembling and/or disassembling them are particularly complex. Furthermore, a special tool is in most instances required for assembling and/or disassembling. Owing to the disassembling and assembling of the faceplate, replacing the operating part that is fastened to a faceplate is complex and bears the risk of damage in the event of a repair.

### SUMMARY

One aspect of the invention is based on the object of providing a method for disassembling and assembling an operating part of an operating device, which method is designed to be particularly simple and reliable.

The object is achieved by the subject matter of the independent patent claims. Advantageous refinements of the invention are described in the dependent patent claims, the description and the FIGURE.

One aspect of the invention relates to a method for disassembling or dismantling an operating part of an operating device from a receptacle unit of the operating device. The operating part comprises a housing, an operating element and a rotary ring. In one aspect of the invention, the operating part is in particular an operating unit which has the housing, the operating element and the rotary ring. The operating part or the operating device is designed as a volume control, for example.

The operating element can be designed as a push button or as a knob. Alternatively, the operating element can be designed as a capacitive operating element. The capacitive operating element can have an operating surface comprising a sensor film. The operating element can have a cylindrical shape.

The rotary ring surrounds the operating element. In other words, the rotary ring encompasses the operating element or borders the operating element. The rotary ring is in particular designed as an annular element which surrounds the operating element. The rotary ring is in particular disposed on an external circumferential face of the operating element. The rotary ring can be coupled and/or connected to the operating element.

By activating the operating element while operating the operating device, such as exerting a predetermined compressive force on the operating element, or touching the operating surface of the operating element, for example, a function can be initiated. Likewise, a function can be initiated by activating the rotary ring while operating the operating device, such as exerting a rotating movement of the rotary ring, in particular in a clockwise manner and/or counterclockwise manner, for example. If the operating part or the operating device is designed as a volume control, for example, a volume can be set by rotating the rotary ring while operating the volume control. The rotary ring can in particular be moved relative to the operating element. In other words, the rotary ring can perform a relative movement or a rotating movement relative to the operating element.

The operating element and the rotary ring are disposed on a first end side of the housing, wherein the housing is coupled to the rotary ring. Additionally, the operating element can also be coupled to the housing. For example, a mounting for the rotary ring and/or the operating element can be disposed in the housing. In particular, the rotary ring can be coupled to an activation shaft which is rotatably disposed in the housing.

In one method, a compressive force is exerted on the operating element, wherein as a result of the compressive force acting on the operating element, a rotating movement of the rotary ring relative to the operating element is blocked. In other words, the rotary ring can be designed in such a way that the rotary ring during disassembling is able to be blocked by pressing down the operating element. In other words, the rotary ring can only be blocked when the operating element is pressed. When a predetermined compressive force is exerted on the operating element, the rotary ring can no longer be rotated about the operating element. As long as no compressive force is exerted on the operating element, the rotary ring is preferably rotatable about the operating element, or the rotary ring can perform a rotation relative to the operating element. In particular, the compressive force, or a predetermined force or pressure, is exerted perpendicularly onto an operating face or an operating surface or an operating field of the operating element, preferably exerted in the direction of a longitudinal axis of the operating device. As a result of the compressive force, the operating element is in particular displaced axially or linearly, as a result of which the rotating movement of the rotary ring relative to the operating element is blocked. As a result of the compressive force, the operating element is in particular displaced or pressed axially in the direction of the first end face of the housing. In particular, the rotary ring is able to be co-rotationally coupled to the operating element as a result of the axial displacement of the operating element.

As a result of the compressive force, the housing located in an installed position and at least partially disposed in the receptacle unit is displaced, in particular axially, from the installed position in the direction of a contact face of the receptacle unit that lies opposite a receptacle opening of the receptacle unit. Prior to exerting the compressive force, the housing of the operating part is in particular located at least partially, thus completely or partially, in the installed position in the receptacle unit. “Installed position” is understood to mean in particular that the operating part, preferably the housing of the operating part, is able to be coupled to the receptacle unit, or is connected to the receptacle unit by a mechanism or is latched in the receptacle unit. If the compressive force is exerted on the operating element, the housing or the operating part is preferably first pushed, in particular axially, further into the receptacle unit. In the process, the housing preferably moves away from the receptacle opening in the direction of a contact face of the receptacle unit. For example, the contact face can form a base or a base area of the receptacle unit.

In a further method, a rotating movement of the rotary ring is exerted, in particular in a counterclockwise manner, as a result of which the operating part is rotated in such a manner that the housing is guided out of the installed position. As a result of the rotating movement of the blocked rotary ring, the housing and the operating element preferably rotate conjointly, in particular automatically. In other words, when the rotary ring is blocked by the compressive force acting on the operating element and the rotary ring is rotated, the entire operating part, thus in particular the housing, the operating element and the rotary ring, can be rotated.

Exerting the compressive force on the operating element and the rotating movement are preferably performed simultaneously or in a temporal sequence. In particular the operating element remains compressed during the rotating movement. When exerting the rotating movement and/or the compressive force, the housing is in particular moved relative to an internal circumferential face of the receptacle unit. Particularly preferably, a predetermined pressure is applied to the operating element, and at the same time the rotary ring, which is blocked as a result, is rotated, in particular in a counterclockwise manner. The rotating movement is in particular performed about a rotation axis of the operating device. In particular, the receptacle unit is not moved or rotated.

In a further method, cancelling the compressive force and moving, in particular automatically moving, the housing to the receptacle opening of the receptacle unit for disassembling the operating part takes place. In particular, the housing or the operating part can be guided vertically upward, thus in the direction of the longitudinal axis of the operating device, out of the receptacle unit, counter to a direction of force of the compressive force. In particular after the compressive force has been cancelled, in particular after the operating element and/or the rotary ring have/has been released, the housing can be moved to the receptacle opening. The housing or the operating part is preferably moved or pulled axially out of the receptacle unit.

For example, the operating part or the rotary ring is designed in such a way that the rotary ring during disassembly is able to be blocked by pressing down the operating element so that the operating element when rotated, in particular when rotated on the rotary ring, is unlatched from the receptacle unit, in particular from the installed position, without tools. In particular, the rotary ring is only blocked when the operating element is pressed. Subsequently, the operating part can be rotated, in particular out of the installed position, by way of the rotary ring. Particularly preferably, the operating part can be unlatched by pressing on the operating element and simultaneously by rotating the in particular blocked rotating ring, in particular in the receptacle unit. In particular, the rotary ring can be rotated without pressure acting on the operating field or the operating element. It can be ensured as a result that no user of the operating device or of the operating part can “accidentally” unlatch the operating element.

This results in the advantage that the operating part is able to be disassembled from the receptacle device in a particularly simple and reliable manner. Furthermore, damage to the operating part can be prevented by the method. Furthermore, working time spent during disassembly is particularly short. Furthermore, no special tools are required for disassembling. Costs can be saved as a result.

The invention also comprises embodiments by way of which additional advantages are derived.

One embodiment provides that the rotary ring has on an inner shell face a first profile. In other words, the rotary ring has on an internal circumferential face a first profile. The internal circumferential face is in particular disposed opposite an external circumferential face of the rotary ring, or faces the operating element. The first profile preferably extends completely in a circumferential direction of the internal circumferential face on the internal circumferential face. Furthermore, the operating element has on a lower side facing the housing and/or on an external circumferential face a second profile. The second profile extends in particular along an external radius of the operating element on the lower side of the operating element and/or in a circumferential direction of the external circumferential face on the external circumferential face of the operating element. When exerting the compressive force on the operating element, the second profile engages in the first profile for blocking the rotating movement of the rotary ring relative to the operating element. The second profile of the operating element preferably engages in the first profile of the rotary ring when a predetermined compressive force is exerted on the operating element. In particular, a predetermined compressive force is applied on the operating element perpendicularly to the receptacle opening. The blocked rotating movement of the rotary ring relative to the operating element is in particular achieved in that the operating element is displaced or moved in particular in the direction of a longitudinal axis of the operating device as a result of the compressive force, the second profile of the operating element thus engaging in the first profile of the rotary ring. As a result, the rotary ring and the operating element are preferably coupled or connected to one another in a form-fitting and/or force-fitting and/or co-rotational manner.

A further aspect of the invention relates to a method for installing or assembling an operating part of an operating device in a receptacle unit of the operating device, wherein the operating part comprises a housing and an operating element and a rotary ring, wherein the rotary ring surrounds the operating element, wherein the operating element and the rotary ring are disposed on a first end side of the housing, wherein the housing is coupled to the rotary ring. In one method, the housing of the operating part is disposed on a receptacle opening of the receptacle unit. In particular, the housing is positioned in the receptacle opening in such a way that the operating part or the housing is able to be introduced into the receptacle unit. In particular, the housing is positioned on or in the receptacle opening of the receptacle unit by way of a second end side that lies opposite the first end side. In particular, the operating part or the housing is introduced into the receptacle unit in particular from above, by way of the receptacle opening.

In a further method, a compressive force is exerted on or applied to the operating element of the operating device, wherein as a result of the compressive force, the housing is displaced through the receptacle opening in the direction of a contact face of the receptacle unit that lies opposite the receptacle opening. If the compressive force is exerted on the operating element, the housing or the operating part is pushed in, in particular axially, preferably into the receptacle unit. In the process, the housing preferably moves from the receptacle opening away in the direction of the contact face of the receptacle unit. For example, the contact face can form a base or a base area of the receptacle unit.

Furthermore, the housing is at least partially received in the receptacle unit. In particular, by pressing the operating part into the receptacle unit, the housing is at least partially, thus completely or partially, disposed in the receptacle unit.

In a further method, performing a rotating movement of the operating part, in particular in a clockwise manner, is performed, as a result of which the housing in the receptacle unit is moved in the direction of an installed position. In particular, the operating part can perform the rotating movement automatically or in a self-acting manner. Exerting the compressive force and the rotating movement is preferably performed simultaneously or in temporal sequence. When performing or exerting the rotating movement, the operating element and the housing rotate conjointly, in particular as a result of the form-fit between the rotary ring and the operating element, and as a result of the rotary ring being coupled to the housing. When performing the rotating movement and/or the compressive force, the housing is in particular moved relative to the internal circumferential face of the receptacle unit. The receptacle unit is in particular not moved or rotated. The rotating movement takes place in particular about a rotation axis or a longitudinal axis of the operating device.

In a further method, cancelling the compressive force and moving, in particular automatically moving, the housing or the operating part to the installed position in the receptacle unit takes place. After cancelling the compressive force, in particular after releasing the operating part or the operating element and/or the rotary ring, the housing, in particular the operating part, can preferably slip or slide into the installed position. The operating part, in particular the housing, can then latch in the installed position. In the installed position, the operating part, preferably the housing of the operating part, is in particular able to be coupled to the receptacle unit, or is connected to the receptacle unit by a mechanism, or is latched in the receptacle unit. The installation is particularly preferably performed by a predetermined pressure acting downward on the operating part, until the operating part rotates itself to the correct position and latches in the latter.

This results in the advantage that the operating part is able to be assembled in a particularly simple and reliable manner in the receptacle unit. Furthermore, damage to the operating part can be prevented by the method. Furthermore, working time spent during assembling is particularly short. Furthermore, no special tools are required for assembling. Costs can be saved as a result.

Additionally or alternatively, it can be provided during assembling that, as a result of the compressive force, a rotating movement of the rotary ring relative to the operating element is blocked. When pressure is exerted on the operating element, the rotary ring can no longer be rotated about the operating element. The blocked rotating movement of the rotary ring relative to the operating element is in particular achieved in that, as a result of the compressive force, the operating element is displaced or moved, in particular in the direction of a longitudinal axis of the operating device, the second profile of the operating element thus engaging in the first profile of the rotary ring. As a result, the rotary ring and the operating element are coupled or connected to one another preferably in a form-fitting and/or force-fitting and/or co-rotational manner.

When the operating part or the housing, for example, does not rotate, in particular automatically, to the installed position during assembling, it can additionally or alternatively be provided that during assembling, in this instance, a rotating movement of the blocked rotary ring of the operating device, in particular in a clockwise manner, is exerted or performed, as a result of which the housing is rotated in such a manner that the housing is guided to the installed position.

Disassembling the operating part and/or assembling the operating part and/or exerting the compressive force and/or performing the rotating movement can be carried out by a user and/or by a robotic arm of a robot.

A further aspect of the invention relates to an operating device for a motor vehicle. The operating device comprises an operating part, wherein the operating part comprises an operating element, a rotary ring and a housing. The operating device or the operating part can be designed as a volume control, for example. The operating element can be designed as a push button or as a knob. Alternatively, the operating element can be designed as a capacitive operating element. The capacitive operating element can have an operating surface which comprises a sensor film. The operating element can have a cylindrical shape.

The rotary ring surrounds the operating element. In other words, the rotary ring encompasses the operating element or borders the operating element. The rotary ring is in particular designed as an annular element which surrounds the operating element. The rotary ring is in particular disposed on an external circumferential face of the operating element. The rotary ring can be coupled and/or connected to the operating element.

By activating the operating element, such as exerting a predetermined compressive force on the operating element, or touching the operating surface of the operating element, for example, a function can be initiated. Likewise, a function can be initiated by activating the rotary ring, such as exerting a rotating movement of the rotary ring, in particular in a clockwise manner and/or counterclockwise manner, for example. If the operating part or the operating device is designed as a volume control, for example, a volume can be set by rotating the rotary ring. The rotary ring can in particular be moved relative to the operating element. In other words, the rotary ring can perform a relative movement relative to the operating element.

The housing can have a cylindrical shape. In other words, the housing can have the shape of a cylinder, in particular of a hollow cylinder. The operating element and the rotary ring are disposed on a first end side of the housing, wherein the housing is coupled to the rotary ring. Additionally, the operating element can also be coupled to the housing. For example, a mounting for the rotary ring and/or the operating element can be disposed in the housing. In particular, the rotary ring can be coupled to an activation shaft which is rotatably disposed in the housing.

Disposed on a shell face of the housing are at least two latching cams at a predetermined spacing, in particular at a uniform mutual spacing. In other words, the at least two latching cams are disposed so as to be mutually spaced apart on an external circumferential face of the housing or an external circumference of the housing. The shell face extends in particular between the first end side and a second end side of the housing. “End side” is understood to mean in particular an end face or base area or covering area of the housing, in particular of the cylindrical housing. The respective end side extends in particular perpendicularly to a longitudinal axis or rotation axis of the housing or of the operating device. The rotation axis extends in particular perpendicularly to the operating surface, and/or runs centrically or centrally through the operating device or the operating surface. The operating device, in particular the rotary ring and/or the operating element and/or the housing, are/is preferably rotatable about the rotation axis.

The at least two latching cams are preferably disposed at a mutual angular spacing of 180°. Three latching cams can preferably be disposed on the shell face. The three latching cams can be disposed at a mutual angular spacing of 120°. “Latching cam” is understood to mean in particular a protrusion or a projecting element or an elevation on the shell face. In particular, the at least two latching cams are fastened or fixed to the shell face. Furthermore, the at least two latching cams are preferably disposed on the same circle on the shell face or the external circumferential face, or on the same plane or at the same height level on the shell face or the external circumferential face, or are disposed centrically between the first end side and the second end side, or at a predetermined spacing from the respective end side.

Furthermore, the operating device comprises a receptacle unit which is specified to at least partially receive the housing. In other words, the receptacle unit can encompass the housing at least partially, thus completely or partially. Preferably, the housing, by way of a part or a region, particularly on or by way of the first end side, protrudes from the receptacle unit. Preferably, the housing is disposed in the receptacle unit by way of the second end side, lying opposite the first end side in particular in the direction of the longitudinal axis of the operating device.

The receptacle unit has at least two guide grooves on an internal circumferential face, wherein the guide grooves are specified to receive in each case one latching cam. In particular, the receptacle unit has at least two guide grooves on an inner side, or on a face that faces the shell face of the housing. “Guide groove” is understood to mean in particular a flute or depression extending on the inner side of the receptacle unit. In particular, one guide groove is in each case assigned to one latching cam. In particular, the guide grooves extend from a receptacle opening of the receptacle unit axially, in particular in the direction of a longitudinal axis of the operating device, in the direction of a contact face of the receptacle unit that lies opposite the receptacle opening, and transition into an arcuate or semicircular portion. “Contact face” is understood to be in particular a base of the receptacle unit.

In an installed position of the housing in the receptacle unit, the housing is at least partially received in the receptacle unit, and one latching cam is in each case disposed in a latched position within the guide groove. “Installed position” is understood to mean in particular that the housing is able to be coupled to the receptacle unit, or is connected to the latter by a mechanism comprising in particular the guide grooves and the latching cams. The latched position is located in particular at the end of the arcuate or semicircular portion of the guide groove. The latching cams particularly preferably interact with the guide grooves in the manner of a latching mechanism, preferably in the manner of a bayonet closure.

This results in the advantage that the operating device is of a particularly simple and robust construction. Furthermore, damage and working times during assembling and/or disassembling of the operating part in the installed position in the receptacle unit can be reduced. Furthermore, no special tools are required for assembling and/or disassembling.

One embodiment provides that the operating device or the operating part comprises at least two spring elements, in particular three spring elements, wherein the spring elements are disposed on a second end side, lying opposite, in particular in the direction of a longitudinal axis of the operating device, the first end side of the housing, wherein the spring elements are specified to hold the latching cams in their latched position. In particular, the at least two spring elements in the installed position of the housing in the receptacle unit generate a counter pressure in such a way that the latching cams are pressed into their latched position. The spring elements are in particular disposed between the second end face of the housing and the contact face of the receptacle unit. This results in the advantage that the housing or the operating part is held in a particularly simple and reliable manner in the receptacle unit.

The at least two spring elements are preferably disposed at a predetermined mutual spacing, in particular uniform spacing, in particular along an external circumference of the housing, on the second end side. For example, the at least two spring elements are disposed on the second end side at a mutual angular spacing of 180°. For example, if the operating device comprises three spring elements, the latter can be disposed at a mutual angular spacing of 120°.

According to an advantageous refinement, the at least two spring elements are designed as arms formed from an elastic material, wherein the arms are aligned at a predetermined angle, in particular of 45°, toward the second end side. In other words, the arms are disposed or aligned so as to be inclined at a predetermined angle, in particular of 45°, toward the second end face. “Arm” is understood to mean in particular a lever or a mechanical link or a mechanical element. The arms are preferably formed from plastics material, in particular from an elastic plastics material.

Particularly preferably, the receptacle unit has a contact face that faces the second end side of the housing, wherein the at least two spring elements in the installed position press against the contact face. In particular, the at least two spring elements in the installed position of the housing in the receptacle unit are disposed by way of one end on the contact face and by way of the other end on the second end side of the housing. The at least two spring elements are in particular disposed between the second end side of the housing and the contact face of the receptacle unit. The spring elements in the installed position of the housing or of the operating part, preferably press the operating part or the housing axially in a vertical direction of the operating device or in the direction of a longitudinal axis or rotation axis of the operating device. By anchoring the latching cams in the latching position, this precludes in particular that the housing or the operating part slides out of the receptacle device. The at least two spring elements are in particular tensioned in the installed position. The angle at which the spring elements are disposed so as to be inclined toward the second end side in the installed position of the housing in the receptacle unit is preferably less than 45°. This results in the advantage that the housing is held in a particularly simple and reliable manner in the receptacle unit.

Advantageously, the rotary ring has on an inner shell face a first profile. In other words, the rotary ring has on an internal circumferential face a first profile. The internal circumferential face is in particular disposed opposite an external circumferential face of the rotary ring, or faces the operating element. The first profile extends preferably completely in a circumferential direction of the internal circumferential face on the internal circumferential face. For example, the first profile can be designed as a gearwheel profile or as a zigzag profile or as a wave profile. Furthermore, the operating element has on a lower side that faces the housing and/or on an external circumferential face a second profile. The second profile extends in particular along an external radius of the operating element on the lower side of the operating element and/or in a circumferential direction of the external circumferential face on the external circumferential face. For example, the second profile can be designed as a gearwheel profile or as a zigzag profile or as a wave profile. Furthermore, the second profile is able to engage in the first profile, in particular for blocking a rotating movement of the rotary ring relative to the operating element. The first profile and the second profile are preferably of identical design, or of a mutually congruent design. For example, if the first profile and the second profile are designed as a gearwheel profile, the teeth of the second gearwheel profile of the operating element can engage between the teeth, or be pushed between the teeth, of the first gearwheel profile of the rotary ring. In particular, the first gearwheel profile and the second gearwheel profile can mesh with one another or engage in one another. Preferably, the second profile of the operating element engages in the first profile of the rotary ring when a predetermined compressive force is exerted on the operating element.

A further embodiment provides that the rotary ring has on an inner shell face a web which extends in an annular manner along the inner shell face. In other words, the rotary ring has on an internal circumferential face, which is in particular disposed opposite an external circumferential face of the rotary ring, or faces the operating element, a web that extends completely in a circumferential direction of the internal circumferential face on the internal circumferential face. The web is in particular disposed between the first end side of the housing and the operating element. The web has the first profile on an upper side facing the operating element. The upper side of the web preferably extends perpendicularly to the inner shell face of the rotary ring.

A specific exemplary embodiment of the method for assembling the operating part of an operating device in the receptacle unit of the operating device, and a specific exemplary embodiment of the method for disassembling the operating part of an operating device from the receptacle unit of the operating device, will be discussed in more detail hereunder by way of example.

In the method for assembling the operating part of the operating device in the receptacle unit of the operating device, in one method the housing can be disposed on the receptacle opening of the receptacle unit and the at least two latching cams can in each case be disposed in a guide groove of the receptacle unit. The housing is in particular positioned in the receptacle opening in such a way that the latching cams are in each case able to be introduced into a guide groove. In particular, the housing is introduced into the receptacle unit in particular from above, by way of the receptacle opening, and the latching cams are moved in position on the guide grooves.

Subsequently, compressive force is exerted on the operating element of the operating device. In particular, a predetermined compressive force is applied to the operating element perpendicularly to the receptacle opening. As a result of the compressive force, the rotating movement of the rotary ring relative to the operating element is blocked. When a pressure is exerted on the operating element, the rotary ring cannot be rotated about the operating element. The blocked rotating movement of the rotary ring relative to the operating element is in particular achieved in that, as a result of the compressive force, the operating element is displaced or moved, in particular in the direction of a longitudinal axis of the operating device, and the second profile of the operating element thus engages in the first profile of the rotary ring. As a result, the rotary ring and the operating element are preferably coupled or connected to one another in a form-fitting manner.

As a result of the compressive force, the latching cams can be displaced in the direction of a contact face lying opposite the receptacle opening. In particular, the latching cams are displaced axially in the guide groove. In other words, the latching cams can be pressed into the receptacle unit so as to be guided in the guide grooves, in particular pressed in the direction of the contact face.

In a further method, a rotating movement of the rotary ring of the operating device can be exerted, in particular in a clockwise manner, as a result of which the housing is rotated in such a manner that the latching cams are guided to a latched position. Exerting the compressive force and the rotating movement are preferably performed simultaneously and in a temporal sequence. When exerting the rotating movement on the rotary ring, the operating element and the housing are rotated, jointly, in particular as a result of the form-fit between the rotary ring and the operating element, and the coupling of the rotary ring to the housing. When exerting the rotating movement and/or the compressive force, the housing is in particular moved relative to the internal circumferential face of the receptacle unit. The receptacle unit is in particular not moved or rotated. The rotating movement is performed in particular about the rotation axis of the operating device.

When exerting the compressive force, the latching cams are preferably displaced in the axial portion of the guide grooves. When exerting the rotating movement, the latching cams are in particular transferred from the axial portion of the guide grooves into the semicircular or arcuate portion of the guide groove.

In a further method, the compressive force can be cancelled and the latching cams can be moved, in particular automatically or in a self-acting manner, to the latched position within the guide groove. In particular, after cancelling the compressive force, in particular after releasing the operating element and/or the rotary ring, the latching cams can slide into the latched position. The movement of the latching cams into the latched position is caused in particular by the spring elements which apply a compressive force, or a counteracting pressure, in particular in the direction of the receptacle opening, on the housing. While exerting the compressive force on the operating element, the spring elements can be tensioned and exert a counteracting pressure. As a result of this counteracting pressure, the latching cams can be pressed into their latched position in the guide groove.

In the method for disassembling the operating part of the operating device in the receptacle unit of the operating device, in one method a compressive force can be exerted on the operating element, wherein as a result of the compressive force acting on the operating element, a rotating movement of the rotary ring relative to the operating element is blocked. The blocked rotating movement of the rotary ring relative to the operating element is achieved in particular in that, as a result of the compressive force, the operating element is displaced or moved, in particular in the direction of a longitudinal axis of the operating device, and the second profile of the operating element thus engages in the first profile of the rotary ring. As a result, the rotary ring and the operating element are preferably coupled or connected to one another in a form-fitting manner.

In a further method, a rotating movement of the rotary ring, in particular in a counterclockwise manner, is exerted. As a result of the rotating movement of the rotary ring, the housing and the operating element rotate conjointly, in particular automatically. Exerting the compressive force on the operating element and the rotating movement are preferably performed simultaneously or in a temporal sequence. When exerting the rotating movement and/or the compressive force, the housing or the operating element is in particular moved relative to the internal circumferential face of the receptacle unit. The receptacle unit is in particular not moved or rotated. The rotating movement is performed in particular about a rotation axis of the operating device.

As a result of the compressive force, the latching cams within the guide grooves can be guided or displaced from a latched position, in particular axially, in the direction of a contact face lying opposite the receptacle opening. As a result of the rotating movement, the latching cams can be displaced or guided about a rotation axis of the operating device, from the latched position within the guide grooves. In other words, when exerting the rotating movement of the rotary ring, the housing or the operating part is rotated in such a manner that the latching cams are guided or moved out of the latched position within the guide grooves. When exerting the compressive force and the rotating movement, the latching cams are preferably displaced or guided in the semicircular or arcuate portion of the guide grooves to the axial portion of the guide grooves.

When disassembling, a pressure is in particular applied to the operating element, and the rotary ring, which is blocked as a result, is simultaneously rotated preferably in a counterclockwise manner. In this way, the latching cams can be pressed downward, thus in the direction of the longitudinal axis, in a direction of force of the compressive force, and can be simultaneously pressed out of their latched position, in particular in a counterclockwise manner.

In a further method, cancelling the compressive force and moving, in particular automatically moving, the latching cams within the guide groove is performed in particular, in particular axially in the direction of the receptacle opening, to the receptacle opening leading out of the receptacle unit. In particular, the latching cams can be guided vertically upward, thus in the direction of the longitudinal axis, counter to a directional force of the compressive force, out of the receptacle unit. The latching cams can be moved to the receptacle opening in particular after cancelling the compressive force, in particular after releasing the operating element and/or the rotary ring.

The predetermined compressive force, or a value of the compressive force which is exerted on the operating element during assembling and/or disassembling, is preferably greater than a compressive force or a value of a compressive force which is exerted on the operating element while activating the operating element.

When assembling the operating part of the operating device in the receptacle unit of the operating device, the housing is in particular disposed in the receptacle unit together with the operating element and the rotary ring disposed on the first end side of the housing. When disassembling the housing or the operating part of the operating device from the receptacle unit of the operating device, the housing is in particular retrieved from the receptacle unit together with the operating element and the rotary ring disposed on the first end side of the housing.

A further aspect of the invention relates to a faceplate or a cover for a motor vehicle having an operating device according to the invention. The receptacle unit of the operating device is disposed on a rear side of the faceplate or the cover, wherein the faceplate or the cover comprises a faceplate opening, wherein the housing is able to be introduced into the receptacle unit by way of the faceplate opening.

The faceplate opening is preferably of round design. The receptacle unit can be disposed on the rear side of the faceplate in such a manner that the faceplate opening and the receptacle opening of the receptacle unit lie on top of one another. In particular, an extent of the receptacle opening and an extent of the faceplate opening are identical. The receptacle opening of the receptacle unit is likewise of round design. In particular, a diameter of the receptacle opening is identical to that of the faceplate opening. In the installed position of the operating part or the housing in the receptacle unit, the operating element and the rotary ring are preferably disposed on a front side, lying opposite the rear side, of the faceplate, and the housing is at least partially received in the receptacle unit.

A further aspect of the invention relates to a motor vehicle having an operating device according to the invention. The operating device is in particular disposed in an interior of the motor vehicle, preferably on a center console of the motor vehicle.

A further aspect of the invention relates to a motor vehicle having a faceplate according to the invention. The faceplate is in particular disposed in an interior of the motor vehicle, preferably on a center console of the motor vehicle.

The motor vehicle according to the invention is preferably designed as a motor car, in particular as a passenger motorcar or as a motor truck, or as a passenger bus or as a motorcycle.

An aspect of the invention also includes refinements of the method according to the invention for assembling an operating part of an operating device in a receptacle unit of the operating device and/or of the operating device according to the invention and/or of the faceplate according to the invention and/or of the motor vehicle according to the invention, which have features that have already been described in the context of the refinements of the operating device according to the invention or of the method according to the invention for disassembling an operating part of an operating device from a receptacle unit of the operating device. For this reason, the corresponding refinements of the method according to the invention for assembling an operating part of an operating device in a receptacle unit of the operating device and/or of the operating device according to the invention and/or of the faceplate according to the invention and/or of the motor vehicle according to the invention are not described once more.

The invention also comprises the combinations of the features of the embodiments described. Thus, the invention also comprises implementations which have in each case a combination of the features of a plurality of the embodiments described, unless the embodiments have been described as mutually exclusive.

### BRIEF DESCRIPTION OF THE DRAWINGS

Exemplary embodiments of the invention are described hereunder. These and other aspects and advantages will become more apparent and more readily appreciated from the following description of the exemplary embodiments, taken in conjunction with the accompanying drawings of which:

FIG. 1 shows an operating device disposed on a faceplate according to an embodiment of the invention.

### DETAILED DESCRIPTION

Reference will now be made in detail to the preferred embodiments, examples of which are illustrated in the accompanying drawings, wherein like reference numerals refer to like elements throughout.

The exemplary embodiments explained hereunder are preferred embodiments of the invention. In the exemplary embodiments, the described components of the embodiments represent in each case individual features of the invention, which are to be considered as mutually independent and also in each case refine the invention in a mutually independent manner. Therefore, the disclosure is also to comprise combinations of the features of the embodiments other than those illustrated. Furthermore, the embodiments described are also able to be refined by further features of the invention that have already been described.

In the FIGURE, the same reference signs denote in each case functionally equivalent elements.

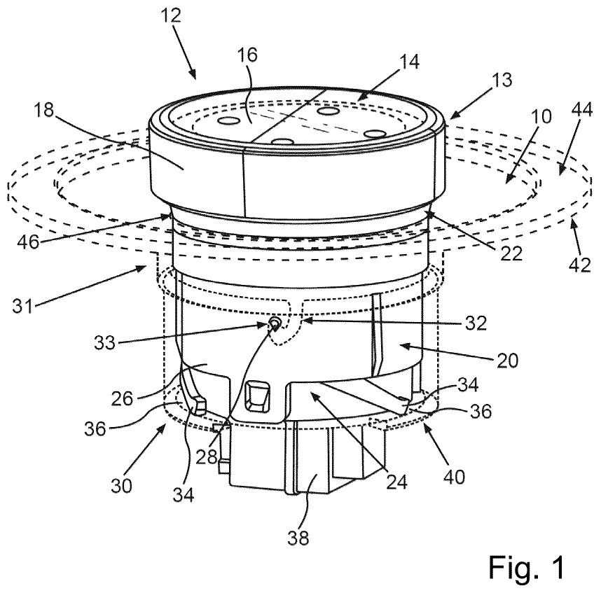

FIG. 1 shows an operating device 12 which is disposed or assembled on a faceplate 10 for a motor vehicle. The operating device 12 is designed as a volume control, for example. The operating device 12 comprises an operating part 13. The operating part 13 has an operating element 14. The operating element 14 has a cylindrical shape. The operating element 14 is designed as a knob or a push button, for example. The operating element 14 has an operating surface 16, in particular a sensitive operating surface 16. The operating surface 16 has, for example, an in particular capacitive sensor film. The operating surface 16 is divided into different operable regions which are identified by different symbols. By operatively handling a respective region, such as pressing or touching the respective region by a user, a function, such as a device function, is able to be controlled. The operating element 14 is movable or displaceable in the direction of a longitudinal axis or the main axis of the operating device 12. In other words, the operating element 14 is axially displaceable. When exerting a compressive force on the operating element 14, the operating element 14 can be displaced or moved in the direction of the longitudinal axis of the operating device 12. If the operating element 14 is released after having been impinged with a compressive force, it can move back to the original position, counter to the direction of the compressive force.

Furthermore, the operating part 13 comprises a rotary ring 18. The rotary ring 18 comprises or borders the operating element 14. In other words, the separate rotary ring 18 can encompass the operating element 14. The rotary ring 18 is disposed along an external circumferential face of the operating element 14. The rotary ring 18 has an annular shape, or has the shape of a hollow cylinder. An inner shell face of the rotary ring 18 faces the operating element 14. The rotary ring 18 can in particular be moved relative to the operating element 14. In the process, the rotary ring 18 can be rotated, in particular about a rotation axis or longitudinal axis of the operating device 12. The rotary ring 18 can be rotated about the operating element 14, in particular when no compressive force is exerted on the operating element 14. If the operating device 12 or the operating part 13 is designed as a volume control, for example, the rotary ring 18 can be utilized for setting the volume. The volume can be increased when rotating the rotary ring 18 in a clockwise manner. A volume can be reduced when rotating the rotary ring 18 in a counterclockwise manner.

Furthermore, the operating part 13 has a housing 20. The rotary ring 18 and/or the operating element 14 are/is coupled or connected to the housing 20. For example, a mounting for the rotary ring 18 and/or the operating element 14 can be received in the housing 20. The rotary ring 18 and/or the operating element 14 are/is disposed on a first end side 22 of the housing 20. The housing 20 has in particular a cylindrical shape. The housing 20 preferably has the shape of a hollow cylinder. The housing 20 comprises the first end side 22 and, in particular in the direction of a direction of main extent or longitudinal axis of the operating device 12, has a second end side 24 lying opposite the first end side 22. A shell face 26 of the housing 20 extends between the first end side 22 and the second end side 24.

As can be derived from the FIGURE, a latching cam 28 is disposed on the shell face 26 of the housing 20. In other words, a latching cam 28 is disposed on an external circumferential face of the housing 20. The operating device 12 has at least two latching cams 28, preferably three or four latching cams. The latching cams 28 are preferably disposed on the shell face 26 so as to be centric between the first end side 22 and the second end side 24. The at least two latching cams 28 are disposed at a predetermined mutual spacing. For example, the two latching cams 28 can be disposed at a mutual angular spacing of 180° on the external circumferential face or the shell face 26. For example, if the operating device 12 has three latching cams 28, the three latching cams can be disposed at a mutual angular spacing of 120°. The latching cams 28 are disposed at the same height level or on the same radius or along the same circle on the external circumferential face or the shell face 26.

Furthermore, the operating device 12 comprises a receptacle unit 30. The receptacle unit 30 is specified to receive the housing 20 of the operating part 13 at least partially, but completely or partially. The housing 20, in particular in an installed position, is at least partially received or disposed in an interior or receptacle region of the receptacle unit 30. A shape of the interior or of the receptacle region of the receptacle unit 30 is adapted to a shape of the housing 20. In the FIGURE, the housing 20 or the operating part 13 is in an installed position in the receptacle unit 30. The housing 20 is able to be introduced into the receptacle unit 30 by way of a receptacle opening 31. The receptacle unit 30 has a face of a guide groove 32 that faces the shell face 26 of the housing 20. In particular, the housing 20 has a guide groove 32 on an internal circumferential face or inner shell face. Only one guide groove 32 is illustrated in the FIGURE The receptacle unit 30 comprises at least two guide grooves 32. The two guide grooves 32 are of the same or identical design. Preferably, the receptacle unit 30 has three guide grooves 32. In particular, the number of guide grooves 32 is identical to the number of latching cams 28. The guide grooves 32 are specified to receive the latching cams 28. The guide grooves 32 are disposed on the internal circumferential face of the receptacle unit 30 at a predetermined mutual spacing, in particular at a uniform spacing. For example, the two guide grooves 32 can be disposed at a mutual angular spacing of 180° on the face or the internal circumferential face. For example, if the operating device 12 has three guide grooves 32, the three guide grooves can be disposed at a mutual angular spacing of 120°.

As can be derived from the FIGURE, the guide groove 32 is J-shaped. The guide groove 32 first extends axially in a direction of main extent, or in the direction of a longitudinal axis, or in the direction of a rotation axis, of the operating device 12. In other words, the guide groove 32 has an axial portion. The guide groove 32, in particular the axial portion, extends so as to proceed from the receptacle opening 31 of the receptacle unit 30. The axial portion transitions into a U-shaped portion or semicircular or arcuate portion. In the FIGURE, the latching cams 28 are in a latched position 33. The latched position 33 is located at the end, or in an end region, of the guide groove 32. The latched position 33 is disposed at the end of the arcuate portion of the guide groove 32.

Furthermore, the operating device 12 or the operating part 13 comprises at least two, preferably three or four, spring elements 34. The spring elements 34 are disposed on or fastened to the second end side 24 of the housing 20. The spring elements 34 are disposed at a predetermined mutual spacing on the second end side 24 of the housing 20. The spring elements 34 are disposed along an external circumference or outer radius on the second end side 24. For example, the two spring elements 34 can be disposed at a mutual angular spacing of 180° on the second end side 24. For example, if the operating device 12 has three spring elements 34, the three spring elements 34 can be disposed at a mutual angular spacing of 120°. The spring elements 34 are preferably formed from an elastic material, for example from an elastic plastics material. The spring elements 34 are designed as arms. The spring elements 34, each designed as an arm, are disposed so as to be inclined at a predetermined angle toward the second end side 24 of the housing 20. For example, the spring elements 34 are disposed so as to be inclined at an angle of 45° toward the second end side 24 of the housing 20, or aligned at an angle of 45° relative to the second end side 24. In particular, the angle is 45° when the spring elements 34 are not tensioned. In the FIGURE, the housing 20 is in an installed position in the receptacle unit 30. In the installed position, the latching cams 28 are in the latched position 33, and the spring elements 30 are tensioned. In the installed position, a compressive force acts on the spring elements 34 in the direction of the rotation axis or in the direction of a longitudinal axis or in a direction of main extent of the operating device 12, in particular from the first end side 22 in the direction of the second end side 24. In order for the latching cams 28 to be held in the latched position, the spring elements 34 exert a counteracting pressure. The counteracting pressure acts in the direction of the rotation axis or in the direction of a longitudinal axis or in the direction of main extent of the operating device 12, in particular from the second end side 24 in the direction of the first end side 22.

Furthermore, the operating device 12 or the operating part 13 comprises a plug 38. With the aid of the plug 38, the operating device 12 or the operating part 13 can be supplied with electrical energy or be connected to an on-board network of a motor vehicle. The plug 38 is disposed on a lower side 40 of the receptacle unit 30. The lower side 40 is located opposite the receptacle opening 31 by way of which the housing 20 is able to be introduced into the receptacle unit 30.

In the FIGURE, the housing 20 or the operating part 13 is in the installed position in the receptacle unit 30. The receptacle unit 30 has a contact face 36 that faces the second end side 24 of the housing 20. In the installed position, the spring elements 34 press against the contact face 36. In the installed position, the spring elements 34 are disposed on the contact face 36. In particular, the spring elements 34 in the installed position are tensioned between the second end side 24 and the contact face 36.

In the FIG. 1, the housing 20 with the operating element 14 disposed thereon and the rotary ring 18 is in the installed position in the receptacle unit 30. The receptacle unit 30 is disposed on or fastened to a rear side 42 of the faceplate 10. The operating element 14 and the rotary ring 18 are disposed on a front side 44, lying opposite the rear side 42, of the faceplate 10. The faceplate 10 can be a faceplate 10 for a motor vehicle. The faceplate 10 or cover can be assembled in an interior of the motor vehicle, in particular on a center console of the motor vehicle. In this instance, the front side 44 of the faceplate 10 forms a visible side of the faceplate 10.

The faceplate 10 has a faceplate opening 46. The faceplate opening 46 is of round design. The receptacle unit 30 is disposed on the rear side 42 of the faceplate 10 in such a manner that the faceplate opening 46 and the receptacle opening 31 of the receptacle unit 30 lie on top of one another. In particular, an extent of the receptacle opening 31 and an extent of the faceplate opening 46 are identical. The receptacle opening 31 is likewise of round design. In particular, a diameter of the receptacle opening 31 is identical to that of the faceplate opening 46.

Installing and removing the operating part 13 in and from the receptacle unit 30 will be discussed in more detail hereunder. For assembling the operating part 13, in particular the housing 20 with the operating element 14 disposed thereon and the rotary ring 18, the housing 20 of the operating part 13 is disposed on the receptacle opening 31. Furthermore, the latching cams 28 are disposed on the guide grooves 32. In the process, the latching cams 28 are disposed on the opening or the introduction region of the guide groove 32. The housing 20 is thus positioned in such a way that the latching cams 28 can be pushed or introduced into the guide grooves 32. The housing 20 is in particular guided through the faceplate opening 46 and/or disposed on the receptacle opening 31 of the receptacle unit 30 perpendicularly to the front side 44 of the faceplate 10. In order for the latching cams 28 to slide into the guide groove 32, a predetermined pressure or a predetermined compressive force is exerted on the operating element 14, in particular perpendicularly to the front side 44 of the faceplate 10 or perpendicularly to the operating surface 16. Simultaneously, the rotary ring 18 is rotated in a clockwise manner. As soon as a compressive force is exerted on the operating element 14, the rotary ring 18 is blocked in such a way that the rotary ring 18 can no longer rotate or move relative to the operating element 14. Thus, if a rotating movement is performed on the rotary ring 18 under the compressive force, the operating element 14, the rotary ring 18 and the housing 20 rotate about a rotation axis of the operating device 12 or about a longitudinal axis of the operating device 12. As a result of the compressive force, the latching cams 28 and/or the housing 20 are guided axially from the receptacle opening 31 in the direction of the contact face 36 or in the direction of the lower side 40 of the receptacle unit 30. As a result of the rotating movement, the latching cams 28 are transferred from the axial portion into the arcuate portion of the guide groove 32 and slide into the latched position 33. In the latched position 33, the spring elements 34 press the latching cams 28 into the latched position 33.

For disassembling the housing 20 from the receptacle unit 30, a compressive force is again exerted on the operating element 14, and the rotary ring 18 is rotated in a counterclockwise manner. The compressive force is exerted perpendicularly to the front side 44 of the faceplate 10 and/or perpendicularly onto the operating surface 16. As a result of the compressive force, the rotary ring 18 is again blocked in such a way that the rotary ring 18 can no longer rotate or move relative to the operating element 14. Thus, if a rotating movement is performed on the rotary ring 18 under the compressive force, the operating element 14, the rotary ring 18 and the housing 20 rotate about the rotation axis of the operating device 12 or about a longitudinal axis of the operating device 12. In this way, the latching cams 28 are pressed downward and simultaneously out of their latched position 33 and can again be guided axially upward out of the guide groove 32.

In order for the rotary ring 18 to be able to be blocked, the rotary ring 18 has on the inner shell face that faces the operating element 14 a web. The web extends in an annular manner along the inner shell face of the rotary ring 18. In other words, the web is disposed on an internal circumferential face of the rotary ring. On an upper side of the web that faces the operating element 14 or is disposed opposite the operating surface 16, the web has a first profile such as, for example, a gearwheel profile or zigzag profile. On a lower side facing the housing 20, the operating element 14 has a second profile such as, for example, a gearwheel profile or zigzag profile, wherein the second profile is able to engage in the first profile.

Overall, the examples show how assembling and/or disassembling an operating device can be achieved from above without tools.

By way of the assembly concept, a volume control can be assembled in the center console faceplate and/or disassembled from the latter without removing and installing the center console faceplate. No special tool is required for assembling and/or disassembling. After contacting the plug, the installation can be performed by the pressure acting downward on the volume control or the operating part or the operating element until the volume control or the operating part rotates itself to the correct position and latches thereon or therein. For disassembling, the operating field or the operating surface of the volume control, or the operating element or the operating part, can be pressed downward, and the volume control rotary ring or the rotary ring, which is blocked as a result, can simultaneously be rotated in a counterclockwise manner until the latching cams are again released from the mounting or the latched position and the volume control or the operating part can be removed toward the top.

The volume control or the operating part cannot be accidentally released because the latter, in the absence of any simultaneous rotation on the rotary ring, would again return to its latched position.

The volume control or the operating part comprises in particular three latching cams by way of which the volume control or the operating part is fixedly held in guide grooves of the holding bracket or of the receptacle unit. If, upon contacting the plug, the volume control is introduced into the mounting or the receptacle unit from above and the three latching cams are moved into position, pressure from above on the operating face or operating surface is sufficient. The three latching cams can slide into the guide grooves and the volume control can rotate automatically into position in such a way that the volume control, once released, slides upward into the latching position or latched position.

Disassembling can take place only when a pressure is applied to the operating field and the rotary ring, which is blocked as a result, or the volume rotary ring is simultaneously rotated in a counterclockwise manner. The operating part can be unlatched again without tools, by pressure and by simultaneously rotating the rotary ring. In the absence of pressure on the operating element the rotary ring can be rotated in such a way that the operating part cannot “accidentally” be unlatched. The rotary ring can be blocked only once the operating field is pressed. Only then can the operating part be twisted out by way of the rotary ring. In this way, the latching cams are pressed downward simultaneously out of their secure position or latched position or latching position toward the right, or in a counterclockwise manner, and can again be removed vertically upward from the mounting or the receptacle unit.

The counteracting pressure can be generated by the three to four restoring springs.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method of disassembling an operating part of an operating device from a receptacle unit of the operating device, comprising:
based on a compressive force being exerted on an operating element of the operating part, which includes a housing and a rotary ring, as a result of which the compressive force acts on the operating element, a rotating movement of the rotary ring relative to the operating element is blocked, the housing located in an installed position and at least partially disposed in the receptacle unit is axially displaced from the installed position along a direction of a contact face of the receptacle unit that lies opposite a receptacle opening of the receptacle unit, the rotary ring surrounding the operating element, the operating element and the rotary ring being disposed on a first end side of the housing, and the housing being coupled to the rotary ring;
based on a rotating movement in a counterclockwise manner being exerted on the rotary ring, as a result of which the operating part is rotated in such a manner that the housing is guided out of the installed position; and
based on the compressive force being cancelled, automatically moving the housing to the receptacle opening of the receptacle unit to thereby allow disassembling the operating part.

2. The method according to claim 1,
wherein the rotary ring has on an inner shell face a first profile,
wherein the operating element has on a lower side facing the housing and/or on an external circumferential face a second profile,
wherein based on the compressive force being exerted on the operating element, the second profile engages in the first profile to block the rotating movement of the rotary ring relative to the operating element.

3. A method of installing an operating part of an operating device in a receptacle unit of the operating device, comprising:
allowing a housing of the operating part to be disposed on a receptacle opening of the receptacle unit enabled for installing the operating part in the receptacle unit, the operating part including an operating element and a rotary ring, which surrounds the operating element, and the operating element and the rotary ring being disposed on a first end side of the housing and the housing being coupled to the rotary ring;
based on a compressive force being exerted on the operating element of the operating device and as a result of the compressive force, the housing is displaced through the receptacle opening along a direction of a contact face of the receptacle unit that lies opposite the receptacle opening, and the housing is at least partially received in the receptacle unit;
based on a rotating movement being performed on the operating part in a clockwise manner, the housing in the receptacle unit moves along a direction of an installed position; and
based on the compressive force being cancelled, the housing is automatically moved to the installed position in the receptacle unit.

4. An operating device for a motor vehicle, comprising:
an operating part which includes an operating element, a rotary ring, which surrounds the operating element, and a housing, the operating element and the rotary ring being disposed on a first end side of the housing, and the housing being coupled to the rotary ring;
at least two latching cams disposed at a predetermined mutual spacing on a shell face of the housing;
a receptacle unit which is specified to at least partially receive the housing, wherein
wherein the receptacle unit has, on an internal circumferential face, at least two guide grooves, and the at least two guide grooves are specified to receive in each case one latching cam among the at least two latching cams, and
while the housing is in an installed position in the receptacle unit, the housing is at least partially received in the receptacle unit, and one latching cam is in each case disposed in a latched position within a guide groove among the at least two guide grooves.

5. The operating device according to claim 4,
wherein the operating device comprises at least two spring elements, the at least two spring elements are disposed on a second end side, lying opposite the first end side, of the housing, and the at least two spring elements are specified to hold the at least two latching cams in a respective latched position.

6. The operating device according to claim 5,
wherein the at least two spring elements are designed as arms formed from an elastic material, and the arms are aligned at a predetermined angle toward the second end side.

7. The operating device according to claim 6,
wherein the predetermined angle at which the arms are aligned is 45°.

8. The operating device according to claim 4,
wherein the at least two latching cams are among at least three latching cams, and the operating device comprises at least three spring elements, the at least three spring elements are disposed on a second end side, lying opposite the first end side, of the housing, and the at least three spring elements are specified to hold the at least three latching cams in a latched position, respectively.

9. The operating device according to claim 5, wherein
the receptacle unit has a contact face that faces the second end side of the housing, and the at least two spring elements, in the installed position, press against the contact face.

10. The operating device according to claim 6,
wherein the receptacle unit has a contact face that faces the second end side of the housing, and the at least two spring elements, in the installed position, press against the contact face

11. The operating device according to claim 4, wherein
the rotary ring has on an inner shell face a first profile, and the operating element has on a lower side facing the housing and/or on an external circumferential face a second profile, and
wherein the second profile is able to engage in the first profile to block a rotating movement of the rotary ring relative to the operating element.

12. The operating device according to claim 11,
wherein the rotary ring has on the inner shell face a web which extends in an annular manner along the inner shell face, and
wherein the first profile is disposed on an upper side of the web that faces the operating element.

13. A faceplate of a motor vehicle having the operating device according to claim 4,
wherein the receptacle unit of the operating device is disposed on a rear side of the faceplate, and
wherein the faceplate has a faceplate opening, and the housing is able to be introduced into the receptacle unit by way of the faceplate opening.

14. A motor vehicle having the operating device according to claim 4 and/or the faceplate according to claim 13.
